(19) United States
(12) Patent Application Publication
(10) Pub. No.: US 2007/0119257 A1
(43) Pub. Date: May 31, 2007

(54) Vibration detection method and system, battery-less vibration sensor and interrogator therefor

(75) Inventors: Junichi Hayasaka, Sendai-shi (JP); Kazumi Tanaka, Sendai-shi (JP); Atsushi Sasaki, Sendai-shi (JP); Chieko Fujiwara, Sendai-shi (JP); Yoshiaki Ikeda, Sendai-shi (JP); Toru Miura, Sendai-shi (JP); Hiroshi Machida, Sendai-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NEC TOKIN Corporation, Sendai-shi (JP)

(21) Appl. No.: 11/594,532

(22) Filed: Nov. 8, 2006

(30) Foreign Application Priority Data
Nov. 11, 2005 (JP) 2005-327855
Feb. 2, 2006 (JP) 2006-025852
Jul. 20, 2006 (JP) 2006-197678

(51) Int. Cl. G01H 11/08

(52) U.S. Cl. 73/649; 310/313 R

(57) ABSTRACT

A vibration detection system comprises a battery-less vibration sensor and an interrogator. The sensor comprises a single port surface acoustic wave resonator. The interrogator continuously transmits a carrier wave signal to the resonator while receiving a wave signal reflected from the resonator. The reflected wave signal includes components other than the transmitted carrier wave signal if the sensor senses a vibration event. Based the reflected wave signal, the interrogator judges whether the vibration event occurs.

### BACKGROUND OF THE INVENTION

This invention relates to a vibration detection method as well as a vibration detection system comprising a vibration sensor and an interrogator.

There are proposed and known various vibration sensors, which are used for, for example, earthquake-proof diagnosis of structures or buildings, detection of glass or pane breakage events, or detection of abnormal vibration in facilities or machine tools.

JP-A 2000-48268 discloses a system that detects momentary and periodical fluctuation such as vibration generated when a glass or pane is broken. The disclosed system includes a vibration sensor fabricated by using a piezoelectric material to transform, into electric signals, vibration generated upon a glass breakage event.

However, the disclosed sensor is too large in size because of its structure. There is a need for a new structure which can reduce a size of a vibration sensor.

### SUMMARY OF THE INVENTION

One aspect of the present invention applies a radio frequency identification (RFID) scheme to a vibration detection method or system to enable a battery-less vibration sensor.

According to one aspect of the present invention, a method for detecting a vibration status of a target object comprises: attaching to the target object a battery-less vibration sensor provided with a single port surface acoustic wave (SAW) resonator, the battery-less vibration sensor being configured to sense the vibration status as mechanical vibration of the battery-less vibration sensor; continuously transmitting a carrier wave signal to the single port SAW resonator; continuously monitoring a wave signal reflected from the single port SAW resonator; and acknowledging the vibration status from fluctuation which is included in the reflected wave signal and is caused by the mechanical vibration.

According to another aspect of the present invention, a vibration detection system comprising: a battery-less vibration sensor comprising a single port surface acoustic wave (SAW) resonator, the battery-less vibration sensor being attached to a target object upon actual use thereof and being configured to sense a vibration status of the target object as mechanical vibration of the battery-less vibration sensor; and an interrogator configured to perform: continuously transmitting a carrier wave signal to the single port SAW resonator; continuously monitoring a wave signal reflected from the single port SAW resonator; and recognizing the vibration status from fluctuation which is included in the reflected wave signal and is caused by the mechanical vibration.

An appreciation of the objectives of the present invention and a more complete understanding of its structure may be had by studying the following description of the preferred embodiment and by referring to the accompanying drawings.

### BRIEF DESCRIPTION OF THE DRAWINGS:

FIG. 1 is a view schematically showing a vibration detection system according to one embodiment of the present invention;

FIG. 2 is a perspective view schematically showing a battery-less vibration sensor of FIG. 1;

FIG. 3 is a sectional view schematically showing a sensor chip of FIG. 2;

FIG. 4 is a top plan view schematically showing a single port SAW resonator of FIG. 3;

FIG. 5 is an enlarged view showing a detail of an oval part indicated in FIG. 4;

FIG. 6 is a block diagram schematically showing an interrogator of FIG. 1;

FIG. 7 is a flowchart showing an exemplary processes carried out in a judgment section of FIG. 6; and

FIG. 8 is a view schematically showing an example application of the system of FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DESCRIPTION OF PREFERRED EMBODIMENTS:

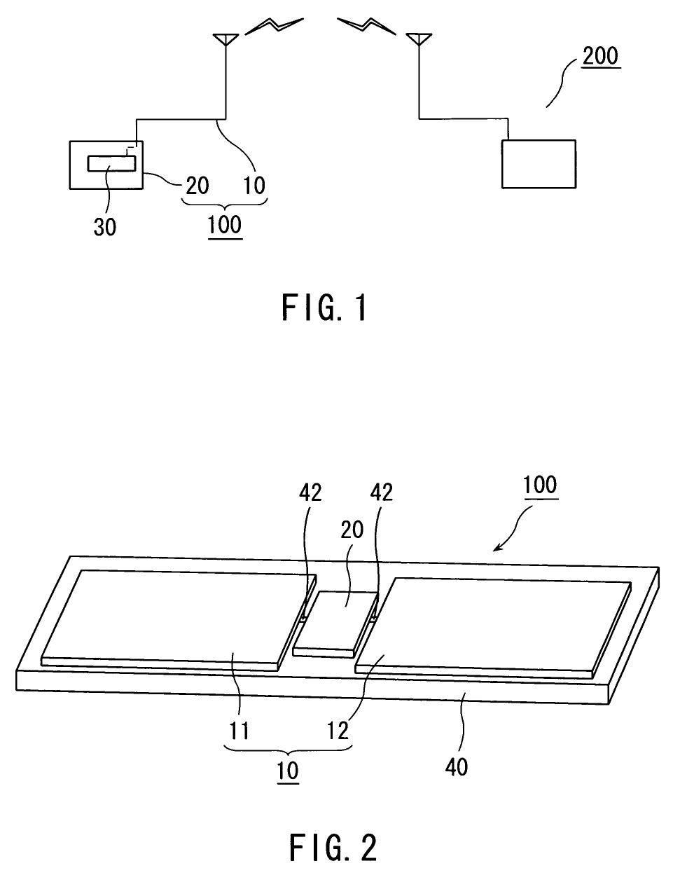

With reference to FIG. 1, a vibration detection system according to one embodiment of the present invention comprises a battery-less vibration sensor 100 and an interrogator 200. The battery-less vibration sensor 100 is attached to a target object such as a glass pane upon its actual use. The interrogator 200 interrogates the battery-less vibration sensor 100 by transmitting a carrier wave signal continuously and receives a reply from the battery-less vibration sensor 100. If the battery-less vibration sensor 100 senses a vibration status or a vibration event of the target object as mechanical vibration of the battery-less vibration sensor 100, its reply to the interrogator 200 includes fluctuation in accordance with the mechanical vibration of the battery-less vibration sensor 100 so that the interrogator 200 can detect the vibration status of the target object.

As shown in FIG. 1, the battery-less vibration sensor 100 comprises an antenna 10 and a sensor chip 20. In the sensor chip 20, a single port SAW resonator 30 is included. The antenna 10 is electrically connected to the single port SAW resonator 30.

As shown in FIG. 2, the battery-less vibration sensor 100 according to the present embodiment is of tag type. In detail, the battery-less vibration sensor 100 further comprises a tag base 40. The tag base 40 of the present embodiment is made of synthetic resins, but the present invention is not limited thereto. For example, the tag base may be made of paper, metal, ceramics, wood or concrete. On the tag base 40, the antenna 10 is formed and the sensor chip 20 is mounted. The illustrated antenna 10 is a set of conductive thin film antennas 11 and 12. The antenna 10, i.e. thin film antennas 11, 12 may be embedded in the tag base 40. Likewise, the sensor chip 20 may be embedded in the tag base 40.

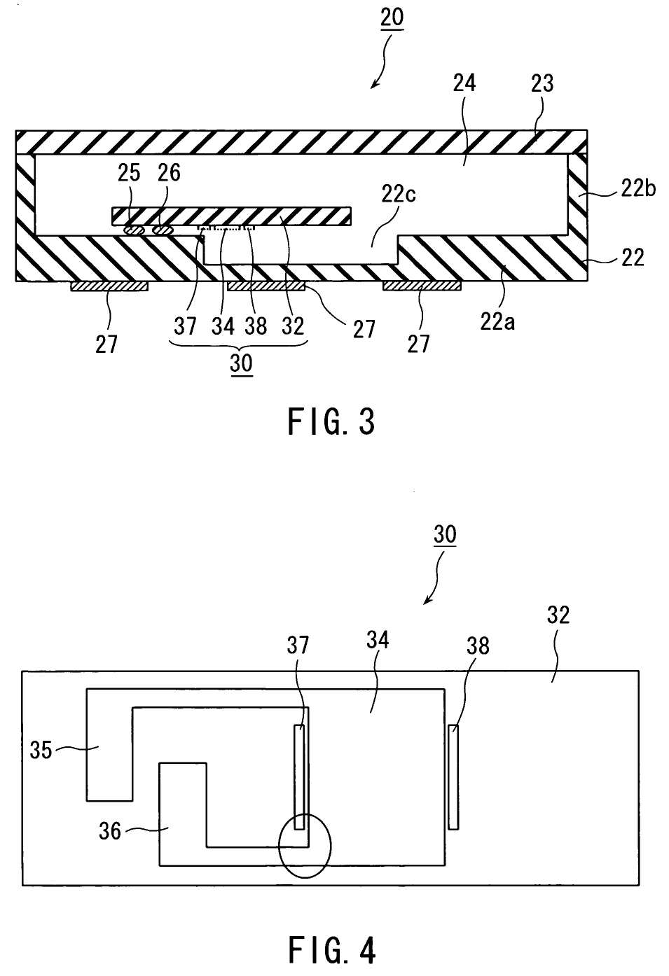

With reference to FIG. 3, the sensor chip 20 comprises a supporter substrate 22 and a cap or lid member 23. The supporter substrate 22 and the cap member 23 define a cavity 24, within which the single port SAW resonator 30 is supported by the supporter substrate 22 so that the single port SAW resonator 30 is vibratable in the cavity 24. In detail, the supporter substrate 22 comprises a main portion 22a of a general plate shape and a side wall portion 22b standing from the main portion 22a. The main portion 22a is formed with a depressed portion 22c. The supporter substrate 22 and the cap member 23 are made of, for example, silicon or ceramics.

The cap member 23 is adhered to a brim of the supporter substrate 22, i.e. a top edge of the side wall 22b, by means of an adhesive agent. Thus, the supporter substrate 22 and the cap member 23 are sealed off so that the cavity 24 is hermetically enclosed.

As shown in FIGS. 3 and 4, the single port SAW resonator 30 of the present embodiment comprises a piezoelectric substrate 32, an inter-digital transducer (IDT) 34 and reflectors 37, 38. The piezoelectric substrate 32 has a plate-like shape. On one surface of the piezoelectric substrate 32, the IDT 34 and the reflectors 37, 38 are formed: The piezoelectric substrate 32 of the present embodiment is made of a langasite (La₃Ga₅SiO₁₄) single crystal but may be made of another single crystal of, for example, quartz, lithium niobate (LiNbO₃), lithium tantalate (LiTaO₃), lithium borate (LBO₂) or zinc oxide.

As shown in FIG. 3, the piezoelectric substrate 32 is supported in cantilever form by the supporter substrate 22 so that the IDT 34 is positioned over the depressed portion 22c. In other words, the piezoelectric substrate 32 has a supported portion and a projecting portion; the supported portion is supported by the supporter substrate 22 while the projecting portion projects over the depressed portion 22c; the IDT 34 is formed on the projecting portion. In this embodiment, the IDT 34 faces the depressed portion 22c. In addition, the IDT 34 is positioned close to the supported portion of the piezoelectric substrate 32. In other words, the IDT 34 is positioned on a root section of the projecting portion of the piezoelectric substrate 32.

As shown in FIGS. 3 and 4, the IDT 34 is formed with connection portions 35, 36, which are connected through solder bumps 25, 26 to a pattern (not shown) formed on the supporter substrate 22; the pattern is further connected to terminals 27 through via holes (not shown) formed in the supporter substrate 22. The terminals 27 are connected to the antennas 11, 12 through wires or traces 42 formed on the tag base 40 (see FIG. 2). Thus, electrical paths are formed between the IDT 34 of the single port SAW resonator 30 and the antennas 11, 12 so that a wave signal received at the antennas 11, 12 is supplied to the IDT 34 through the electrical paths; the IDT 34 reflects the received wave signal, and the reflected wave signal is transmitted through the electrical paths and the antennas 11, 12 to the interrogator 200. In this embodiment, an impedance-matching is ensured at every boundary on the electrical paths so that undesirable reflection is not included in the reflected wave signal.

The piezoelectric substrate 32 of the present embodiment has a specific shape in accordance with which a resonant frequency of the single port SAW resonator 30 belongs to an exemplary frequency band of mechanical vibration of a detection target object, ex. a frequency band representative of a glass breakage event in a case of detection of glass breakage. The thus adjusted resonant frequency results in continuing vibration of the piezoelectric substrate 32 even after vibration of the target object ceases. In this embodiment, the piezoelectric substrate 32 has a constant thickness so that its resonant frequency is adjustable by changing a length of the projecting portion of the piezoelectric substrate 32.

The reflectors 37, 38 of the present embodiment are arranged in proximity to the IDT 34 to serve as an energy blocker blocking or preventing energy of the received carrier wave signal from escaping from the IDT 34 or surroundings of the IDT 34. In this embodiment, two reflectors 37, 38 are used. In consideration of the magnitude of allowable energy loss, any one or both of them may be omitted.

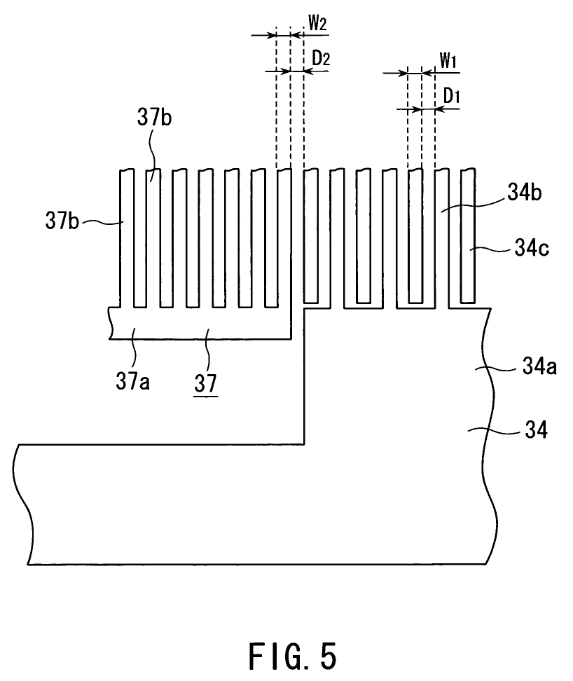

As shown in FIG. 5, the IDT 34 comprises two base portions, only one of which is shown with a reference numeral 34a, and two set of fingers 34b, 34c. Each of the fingers 34b projects from the base portion 34a upwardly in FIG. 5. Each of the other fingers 34c projects downwardly from the other base portion that is not shown in FIG. 5. The fingers 34b and the other fingers 34c are alternately arranged at regular intervals. Each finger 34b, 34c has a width W₁ and extends along a vertical direction in FIG. 5. Neighboring two fingers 34b and 34c are positioned away from each other by a distance D. In this embodiment, the width W₁ is equal to the distance D₁.

The reflector 37 also comprises a base portion 37a and a plurality of fingers 37b extending from the base portion 37a along the vertical direction in FIG. 5. The illustrated finger 37b has a width W₂ equal to the width W₁ of the finger 37b, 37c. An end one of the fingers 37b is positioned away by a distance D₂ from an end one of the finger 37b, 37c. In other words, the reflector 37 is positioned away from the IDT 34 by the distance D₂ in a horizontal direction in FIG. 5. Preferably, the distance D₂ is equal to an integral multiple of the distance D₁. In this embodiment, the distance D₂ is equal to the distance D₁. The distance D₂ may be equal to two or more times of the distance D₁. The other reflector 38 of the present embodiment has a shape same as that of the reflector 37 and is arranged in a manner similar to that of the reflector 37.

The distance D₁ has an influence on the resonant frequency at the single port SAW resonator 30. In this embodiment, the distance D₁ is determined and designed so that the resonant frequency at the single port SAW resonator 30 is equal to a frequency of the carrier wave signal transmitted from the interrogator 200.

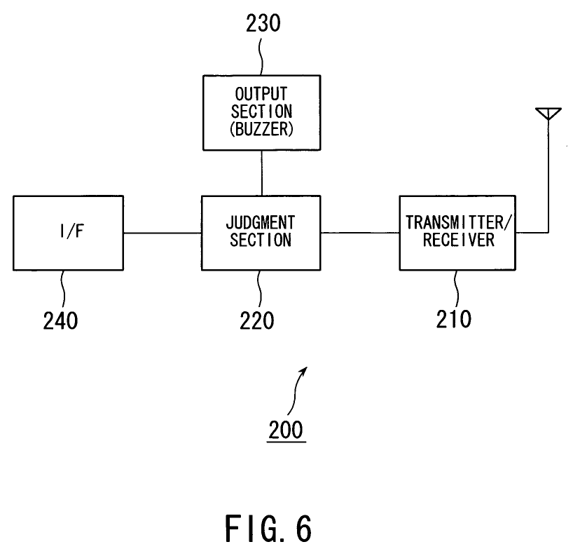

With reference to FIG. 6, the interrogator 200 comprises a transmitter/receiver 210, a judgment section 220, an output section 230 and an interface (I/F) section 240.

The transmitter/receiver 210 has a function to continuously transmit a carrier wave signal to the battery-less vibration sensor 100 and another function to receive a wave signal reflected from the battery-less vibration sensor 100. The exemplary transmitter/receiver 210 comprises a transmitter for continuously transmitting the carrier wave signal, a circulator, an antenna, and a receiver for receiving the reflected wave signal. In this embodiment, the transmitter/receiver 210 continues to transmit the carrier wave signal even when receiving the reflected wave signal. In other words, the transmitter/receiver 210 of the present embodiment carries out the transmission of the carrier wave signal and the reception of the reflected wave signal.

The carrier wave signal of the present embodiment consists of a single frequency component, namely, is shown in a simple sinusoidal wave signal. However, the carrier wave signal may comprises multiple frequency components, provided that the carrier wave signal is not a momentary pulse but has a periodical change. Preferably, the carrier wave signal has a periodical, smooth change to make it easy to recognize a difference between the carrier wave signal and the reflected wave signal.

The judgment section 220 is connected to the transmitter/receiver 210 and has a function to monitor the reflected wave signal to judge whether the target object is in the vibration status. When the battery-less vibration sensor 100 senses a vibration event of the target object, the single port SAW resonator 30 reflects the received carrier wave signal with vibration information included therein. For example, the vibration information is at least one of an amplitude, a frequency and a phase which are not of the carrier wave signal. In other words, the single port SAW resonator 30 modulates the received carrier wave signal in accordance with the sensed vibration event. Therefore, the judgment section 220 judges that the target object is in vibration status, when recognizing the above-mentioned modulation.

The output section 230 is coupled to the judgment section 220 and serves to, if the judgment section 220 judges that the target object is in vibration status, notify a user of the judgment. In this embodiment, the output section 230 comprises a buzzer.

The I/F section 240 is connected between the judgment section 220 and an upper apparatus or section/unit not shown. The I/F section 240 serves to, if the judgment section 220 judges that the target object is in vibration status, notify the upper apparatus of the judgment.

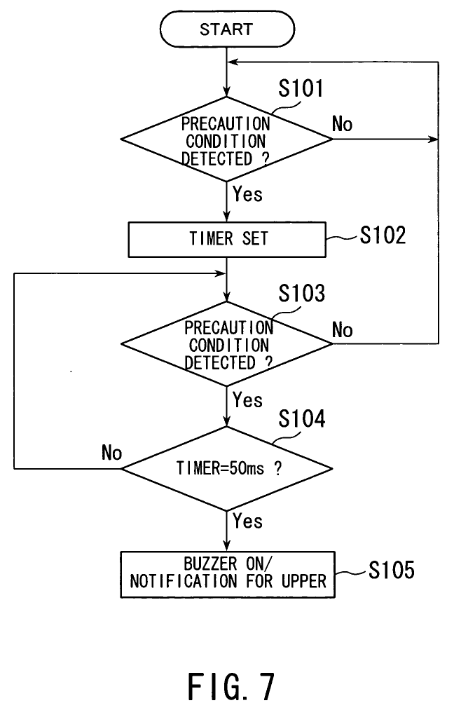

The exemplary judgment processes by the judgment section 220 are shown in FIG. 7; the judgment section 220 of this example comprises a timer. When detecting a precaution condition under which the reflected wave signal includes modulated components which are not of the carrier wave signal (S101), the judgment section 220 sets its timer for 50 ms (S102). Then, the judgment section 220 monitors whether the precaution condition continues (S103). If the precaution condition continues for 50 ms (S104), the judgment section 220 judges that the target object is in vibration status. After the judgment, the judgment section 220 turns the buzzer on and notifies the upper apparatus of the detection of the vibration status by means of the I/F section 240.

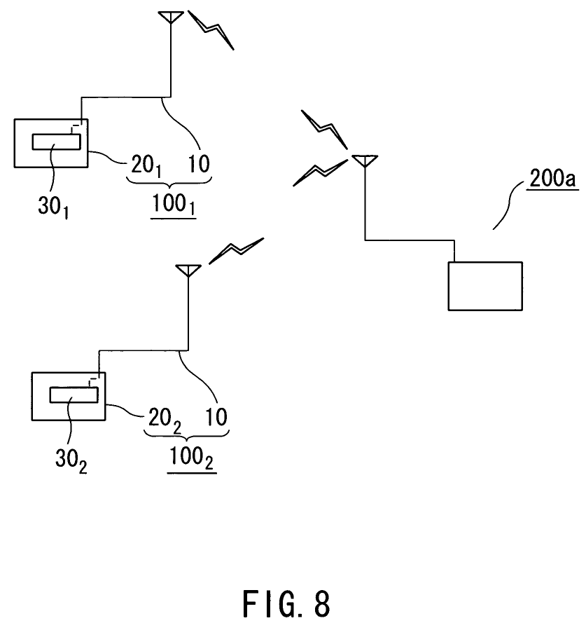

Although the system of the present embodiment comprises a single battery-less vibration sensor, the present invention is not limited thereto. A vibration detection system may comprise a plurality of battery-less vibration sensors. Especially, as shown in FIG. 8, a vibration detection system may comprise a single interrogator 200a and a plurality of battery-less vibration sensors 100₁, 100₂, which include single port SAW resonators 30₁, 30₂, respectively. The single port SAW resonators 30₁, 30₂ have similar structure to that of the above-explained resonator 30. The single port SAW resonators 30₁, 30₂ have different resonant frequencies from each other by, for example, selecting suitable lengths of projecting portions of their piezoelectric substrates. The interrogator 200a identifies the battery-less vibration sensors 100₁, 100₂ on the basis of the different resonant frequencies of their single port SAW resonators 30₁, 30₂.

The present application is based on Japanese patent applications of JP2005-327855, JP2006-025852 and JP2006-197678 filed before the Japan Patent Office on Nov. 11, 2005, Jan. 11, 2006 and Jul. 20, 2006, respectively, the contents of which are incorporated herein by reference.

While there has been described what is believed to be the preferred embodiment of the invention, those skilled in the art will recognize that other and further modifications may be made thereto without departing from the sprit of the invention, and it is intended to claim all such embodiments that fall within the true scope of the invention.

What is claimed is:

1. A method for detecting a vibration status of a target object, comprising:
attaching to the target object a battery-less vibration sensor provided with a single port surface acoustic wave (SAW) resonator, the battery-less vibration sensor being configured to sense the vibration status as mechanical vibration of the battery-less vibration sensor;
continuously transmitting a carrier wave signal to the single port SAW resonator;
continuously monitoring a wave signal reflected from the single port SAW resonator, the reflected wave signal including fluctuation caused by the mechanical vibration when the battery-less vibration sensor senses the vibration status; and
noticing the vibration status on the basis of the fluctuation.

2. The method according to claim 1, wherein the continuously-transmitting and the continuously-monitoring are carried out simultaneously.

3. The method according to claim 1, wherein the noticing comprises checking whether the reflected wave signal includes at least one of amplitude, frequency and phase all belonging not to the carrier wave signal.

4. A vibration detection system comprising:
a battery-less vibration sensor comprising a single port surface acoustic wave (SAW) resonator, the battery-less vibration sensor being attached to a target object upon actual use thereof and being configured to sense a vibration status of the target object as mechanical vibration of the battery-less vibration sensor; and
an interrogator configured to perform: continuously transmitting a carrier wave signal to the single port SAW resonator; continuously monitoring a wave signal reflected from the single port SAW resonator, the reflected wave signal including fluctuation caused by the mechanical vibration when the battery-less vibration sensor senses the vibration status; and noticing the vibration status on the basis of the fluctuation.

5. The vibration detection system according to claim 4, wherein the interrogator is configured to carry out the continuous transmission of the carrier wave signal and the monitoring of the reflected wave signal simultaneously.

6. The vibration detection system according to claim 4, wherein the interrogator is configured to notice the vibration status by checking whether the reflected wave signal includes at least one of an amplitude, a frequency and a phase all belonging not to the carrier wave signal.

7. A battery-less vibration sensor attachable to a target object, comprising:
an antenna; and
a single port surface acoustic wave (SAW) resonator electrically connected to the antenna.

8. The battery-less vibration sensor according to claim 7, being attachable to a target object and sensing a vibration status of the target object as mechanical vibration of the battery-less vibration sensor, wherein:
the antenna is configured to receive a carrier wave signal to pass the received carrier wave signal to the single port SAW resonator and is configured to transmit a wave signal reflected from the single port SAW resonator; and
the single port SAW resonator is configured so that, if the target object is under the vibration status, the reflected wave signal includes fluctuation caused by the mechanical vibration.

9. The battery-less vibration sensor according to claim 8, wherein the single port SAW resonator comprises a piezoelectric substrate, an inter-digital transducer (IDT) formed on the piezoelectric substrate, the battery-less vibration sensor further comprising a supporter substrate supporting the piezoelectric substrate.

10. The battery-less vibration sensor according to claim 9, wherein the single port SAW resonator further comprises an energy blocker configured to block energy of the received carrier wave signal from escaping from the IDT or surroundings of the IDT.

11. The battery-less vibration sensor according to claim 10, wherein:
the IDT comprises a plurality of fingers, each of the fingers extending along a first direction, the fingers being arranged in a second direction perpendicular to the first direction, the fingers consisting of two end fingers in the second direction and remaining fingers positioned between the end fingers; and
the energy blocker comprises at least one reflector, the reflector being formed on the piezoelectric substrate and being positioned in proximity to one of the end fingers in the second direction.

12. The battery-less vibration sensor according to claim 11, wherein:
the fingers are arranged at regular intervals, neighboring two fingers being positioned away from each other by a first distance; and
the reflector is positioned away from the end finger by a second distance, the second distance being equal to an integral multiple of the first distance.

13. The battery-less vibration sensor according to claim 9, wherein the piezoelectric substrate has a specific shape leading a resonant frequency of the single port SAW resonator to belong to an exemplary frequency band of the mechanical vibration.

14. The battery-less vibration sensor according to claim 9, wherein:
the supporter substrate comprises a main portion of a plate shape formed with a depressed portion; and
the piezoelectric substrate is supported so that the IDT is positioned over the depressed portion.

15. The battery-less vibration sensor according to claim 14, wherein the piezoelectric substrate is supported so that the IDT faces the depressed portion.

16. The battery-less vibration sensor according to claim 9, wherein the piezoelectric substrate is supported in cantilever form.

17. The battery-less vibration sensor according to claim 9, further comprising a cap member, wherein:
the cap member and the supporter substrate define a cavity; and
the piezoelectric substrate supported so that the piezoelectric substrate is vibratable in the cavity.

18. The battery-less vibration sensor according to claim 17, wherein the cap member and the supporter substrate are sealed off.

19. The battery-less vibration sensor according to claim 7, further comprising a tag base provided with the antenna.

20. The battery-less vibration sensor according to claim 19, wherein:
the antenna is formed on the tag base; and
the single port SAW resonator is mounted on the tag base so that the battery-less vibration sensor is formed in tag form.

21. The battery-less vibration sensor according to claim 19, wherein:
the antenna is formed on the tag base; and
the single port SAW resonator is embedded in the tag base so that the battery-less vibration sensor is formed in tag form.

22. The battery-less vibration sensor according to claim 19, wherein:
the antenna is formed in the tag base; and
the single port SAW resonator is mounted on the tag base so that the battery-less vibration sensor is formed in tag form.

23. The battery-less vibration sensor according to claim 19, wherein:
the antenna is formed in the tag base; and
the single port SAW resonator is embedded in the tag base so that the battery-less vibration sensor is formed in tag form.

24. The battery-less vibration sensor according to claim 19, wherein:
the tag base is made of synthetic resins, paper, metal, ceramics, wood or concrete; and
the antenna is made of a conductive thin film.

25. An interrogator usable in a vibration detection system comprising battery-less vibration sensor, the battery-less vibration sensor being attached to a target object upon actual use thereof and being configured to sense a vibration status of the target object as mechanical vibration of the battery-less vibration sensor, the interrogator comprising:
a transmitter/receiver configured to continuously transmit a carrier wave signal to the battery-less vibration sensor and configured to continuously receive a wave signal reflected from the battery-less vibration sensor, the reflected wave signal including fluctuation caused by the mechanical vibration when the battery-less vibration sensor senses the vibration status; and
a judgment section coupled to the transmitter/receiver and configured to monitor the reflected wave signal to judge, on the basis of the fluctuation, whether the target object is in the vibration status.

26. The interrogator according to claim 25, wherein the judgment section is configured to perform:
checking whether the reflected wave signal includes at least one of amplitude, frequency and phase all belonging not to the carrier wave signal; and
on the basis of a result of the check, judging whether the target object is in the vibration status.

27. The interrogator according to claim 25, wherein the judgment section is configured to perform:
detecting a precaution condition under which the reflected wave signal includes at least one of amplitude, frequency and phase which are not of the carrier wave signal;
monitoring whether the precaution condition continues for a predetermined period; and
in a case where the precaution condition continues for the predetermined period, judging that the target object is in the vibration status.

28. A vibration detection system based on a radio frequency identification scheme, the vibration detection system comprising:
an interrogator configured to continuously transmit a carrier wave signal; and
a battery-less vibration sensor configured to sense a vibration event by using electromagnetic energy of the carrier wave signal.
